(19) United States
(12) Patent Application Publication
(10) Pub. No.: US 2021/0312551 A1
(43) Pub. Date: Oct. 7, 2021

(54) METHOD AND APPARATUS FOR RESOURCE EXCHANGE

(71) Applicant: ALIPAY (HANGZHOU) INFORMATION TECHNOLOGY CO., LTD., Hangzhou (CN)

(72) Inventor: Jiankang SUN, Hangzhou (CN)

(21) Appl. No.: 17/349,580

(22) Filed: Jun. 16, 2021

(30) Foreign Application Priority Data
Jul. 3, 2020 (CN) 202010630662.2

(51) Int. Cl. G06Q 40/04; G06Q 20/06

(52) U.S. Cl. CPC G06Q 40/04; G06Q 20/065

(57) ABSTRACT

A method includes: in response to a scanning operation by a user on a graphic code output by a resource exchange terminal, jumping to a resource exchange interface, wherein the resource exchange interface includes information of an account of a resource receiver; obtaining information of an account of a resource provider and a resource exchange amount input by the user on the resource exchange interface; according to the information of the account of the resource receiver, the information of the account of the resource provider, and the resource exchange amount, generating a resource exchange request, and sending the resource exchange request to a resource exchange server, causing the resource exchange server to respond to the resource exchange request.

### CROSS REFERENCE TO RELATED APPLICATIONS

This application claims priority to and benefits of Chinese Patent Application No. 202010630662.2 filed on Jul. 3, 2020, the content of which is incorporated herein by reference in its entirety.

### TECHNICAL FIELD

One or more embodiments of the present specification relate to the field of network communication, and in particular, to a method and an apparatus for resource exchange.

### BACKGROUND

Types of resources required by a user may be different from types of resources owned by the user. Under some application conditions, exchanging the resources owned by the user with another resource type has become an urgent problem to be solved.

### SUMMARY OF THE INVENTION

In view of this, one or more embodiments of the present specification provide a resource exchange method. The method includes: obtaining, by a processor of a user terminal, a graphic code displayed on a resource exchange terminal; in response to obtaining the graphic code, jumping, by the processor of the user terminal, to a resource exchange interface, wherein the resource exchange interface comprises information of an account of a resource receiver; obtaining, by the processor of the user terminal, information of an account of a resource provider and a resource exchange amount input by a user on the resource exchange interface; and according to the information of the account of the resource receiver, the information of the account of the resource provider, and the resource exchange amount, generating, by the processor of the user terminal, a resource exchange request, and sending the resource exchange request to a resource exchange server, causing the resource exchange server to: transfer resources of a first type corresponding to the resource exchange amount from the account of the resource provider to the account of the resource receiver, and after the transfer of the first type of resources is completed, instruct the resource exchange terminal to release resources of a second type corresponding to the resource exchange amount to the user, wherein the second type is different from the first type.

In some embodiments, the generating a resource exchange request includes: displaying a prompt information interface for confirming the information of the account of the resource receiver; and in response to a confirmation operation by the user on the information of the account of the resource receiver, generating the resource exchange request according to the information of the account of the resource receiver, the information of the account of the resource provider, and the resource exchange amount.

In some embodiments, the resource exchange interface includes a confirmation option for confirming the information of the account of the resource receiver; and the confirmation operation includes a trigger operation on the confirmation option.

In some embodiments, the first type of resources comprises electronic currency, and the second type of resources comprises cash currency.

In some embodiments, the resource exchange comprises cross-currency cash withdrawal.

In some embodiments, the method further includes: in response to an operation by a user on the resource exchange terminal, outputting, by a processor of the resource exchange terminal, the graphic code; receiving, by the processor of the resource exchange terminal, an instruction issued by the resource exchange server after completing the transfer of the first type of resources; and in response to receiving the instruction, releasing, by the processor of the resource exchange terminal, the second type of resources corresponding to the resource exchange amount to the user.

In some embodiments, the method further includes: displaying an user interface on the resource exchange terminal, wherein the user interface comprises a function entry for triggering a resource exchange; and in response to a trigger operation on the function entry, outputting the graphic code.

In some embodiments, the method further includes: in response to a scanning operation on the graphic code by the user terminal, outputting a voice prompt for confirming the information of the account of the resource receiver included in the resource exchange interface.

In some embodiments, in response to the instruction, releasing the second type of resources corresponding to the resource exchange amount to the user comprises: in response to the instruction, outputting to the user through the user interface of the resource exchange terminal a prompt message for releasing the second type of resources corresponding to the resource exchange amount to the user.

One or more embodiments of the present specification further provide one or more non-transitory computer-readable media configured with instructions executable by a resource exchange system to cause the resource exchange system to perform operations including: obtaining, by a processor of a user terminal of the resource exchange system, a graphic code displayed on a resource exchange terminal of the resource exchange system; in response to obtaining the graphic code, jumping, by the processor of the user terminal, to a resource exchange interface, wherein the resource exchange interface comprises information of an account of a resource receiver; obtaining, by the processor of the user terminal, information of an account of a resource provider and a resource exchange amount input by a user on the resource exchange interface; and according to the information of the account of the resource receiver, the information of the account of the resource provider, and the resource exchange amount, generating, by the processor of the user terminal, a resource exchange request, and sending the resource exchange request to a resource exchange server of the resource exchange system, causing the resource exchange server to: transfer resources of a first type corresponding to the resource exchange amount from the account of the resource provider to the account of the resource receiver, and after the transfer of the first type of resources is completed, instruct the resource exchange terminal to release resources of a second type corresponding to the resource exchange amount to the user, wherein the second type is different from the first type.

One or more embodiments of the present specification further provide a system including a user terminal, a resource exchange terminal, and a resource exchange server. The user terminal is configured to perform operations including: obtaining a graphic code displayed on the resource exchange terminal; in response to obtaining the graphic code, jumping to a resource exchange interface, wherein the resource exchange interface comprises information of an account of a resource receiver; obtaining information of an account of a resource provider and a resource exchange amount input by a user on the resource exchange interface; and according to the information of the account of the resource receiver, the information of the account of the resource provider, and the resource exchange amount, generating a resource exchange request, and sending the resource exchange request to the resource exchange server, causing the resource exchange server to: transfer resources of a first type corresponding to the resource exchange amount from the account of the resource provider to the account of the resource receiver, and after the transfer of the first type of resources is completed, instruct the resource exchange terminal to release resources of a second type corresponding to the resource exchange amount to the user, wherein the second type is different from the first type.

In some embodiments, the resource exchange terminal includes a merchant terminal; the resource exchange interface includes a cash withdrawal interface; the account of the resource receiver includes a receiving account; the account of the resource provider includes an outgoing account; and the resource exchange amount includes a remittance amount.

In some embodiments, the information of the receiving account includes: information of a receiving account of the merchant; or information of a third party receiving account designated by the merchant.

In some embodiments, the merchant terminal is equipped with a box for containing cash and cash management intelligent hardware. The step of in response to the instruction, releasing the second type of resources corresponding to the resource exchange amount to the user includes: in response to the instruction, controlling the cash management intelligent hardware mounted on the merchant terminal to output cash in an amount corresponding to the remittance amount from the cash contained in the box.

The present specification also proposes a computer device, including a memory and a processor, wherein the memory stores a computer program executable by the processor; and when executing the computer program, the processor executes a resource exchange method executed by a user terminal.

The present specification also proposes a computer device, including a memory and a processor, wherein the memory stores a computer program executable by the processor; and when executing the computer program, the processor executes a resource exchange method executed by a resource exchange terminal.

Based on the resource exchange method, apparatus, and computer device provided by the various embodiments of the present specification, through the information exchange between a client of a user terminal and the resource exchange terminal, the user can execute a transfer of a first type of resources to an account of a resource receiver designated by a resource exchange service user, thereby conveniently and quickly obtaining a second type of resources corresponding to an amount of the transferred first type of resources.

By applying the above resource exchange method to occasions when a user gets cash in a merchant, and based on information exchange between a client of a user terminal and a merchant terminal, the user can execute a remittance to a receiving account designated by the merchant, thereby conveniently and quickly obtaining cash.

### BRIEF DESCRIPTION OF THE DRAWINGS

FIG. 1 is a flow chart of a resource exchange method provided by an exemplary embodiment.

FIG. 2 is a schematic diagram of a cash withdrawal system including a cash withdrawal client of a user terminal, a merchant terminal, a withdrawal service server, and a remittance server provided by an exemplary embodiment.

FIG. 3 is a flow chart of a cash withdrawal method provided by an exemplary embodiment.

FIG. 4 is a flow chart of a cash withdrawal method provided by another exemplary embodiment.

FIG. 5 is a schematic diagram of a resource exchange apparatus applied to a client of a user terminal provided by an exemplary embodiment.

FIG. 6 is a schematic diagram of a resource exchange apparatus applied to a resource exchange terminal provided by an exemplary embodiment.

FIG. 7 is a hardware structure diagram for implementing the resource exchange apparatus provided in the present specification.

### DETAILED DESCRIPTION

Here, exemplary embodiments will be described in detail, and examples thereof are shown in the accompanying drawings. When the following description refers to the accompanying drawings, unless otherwise indicated, the same numbers in different drawings indicate the same or similar elements. The embodiments described in the following exemplary embodiments do not represent all the exemplary embodiments consistent with one or more exemplary embodiments of the present specification. Rather, they are merely examples of apparatuses and methods consistent with some aspects of one or more embodiments of the present specification as detailed in the appended claims.

It should be noted that in other embodiments, steps of a corresponding method are not necessarily executed in the order shown and described in the present specification. In some other embodiments, the method may include more or fewer steps than described in the present specification. In addition, a single step described in the present specification may be decomposed into multiple steps for description in other embodiments; and multiple steps described in the present specification may also be combined into a single step in other embodiments for description.

Types of resources required by a user may be different from types of resources owned by the user. Under some application conditions, exchanging the resources owned by the user with another resource type has become an urgent problem to be solved.

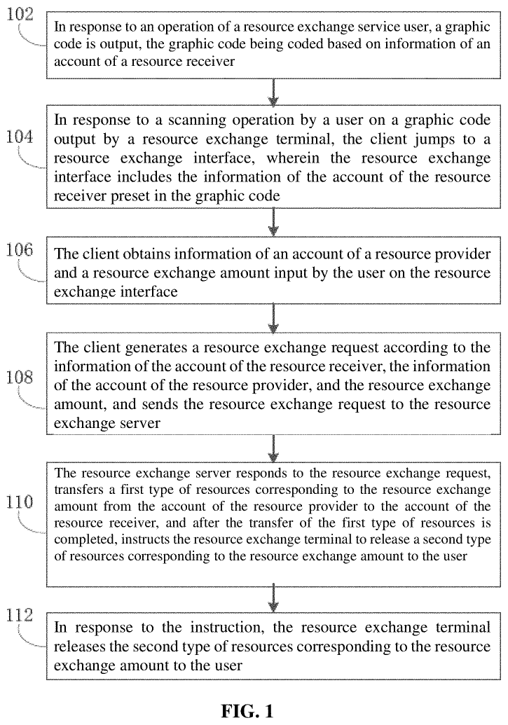

In view of this, an exemplary embodiment of the present specification provides a resource exchange method, which is applied to a resource exchange system including a client of a user terminal, a resource exchange terminal, and a resource exchange server, as shown in FIG. 1. The resource exchange method includes the following steps.

At Step 102, in response to an operation of a resource exchange service user, a graphic code is output (e.g., displayed), the graphic code being coded based on information of an account of a resource receiver.

Resource exchange service users include users (e.g., merchants) operating resource exchange terminals, to provide resource exchange services for other users (e.g., customers). The account of the resource receiver may be an account held by the resource exchange service user, or may be an account held by other users.

At Step 104, in response to a scanning operation by a user on a graphic code output by a resource exchange terminal, the client jumps to a resource exchange interface, wherein the resource exchange interface includes the information of the account of the resource receiver preset in the graphic code.

At Step 106, the client obtains information of an account of a resource provider and a resource exchange amount which are input by the user on the resource exchange interface.

At Step 108, the client generates a resource exchange request according to the information of the account of the resource receiver, the information of the account of the resource provider, and the resource exchange amount, and sends the resource exchange request to the resource exchange server.

At Step 110, the resource exchange server responds to the resource exchange request, transfers a first type of resources corresponding to the resource exchange amount from the account of the resource provider to the account of the resource receiver, and after the transfer of the first type of resources is completed, instructs the resource exchange terminal to release a second type of resources corresponding to the resource exchange amount to the user.

At Step 112, in response to the instruction, the resource exchange terminal releases the second type of resources corresponding to the resource exchange amount to the user.

The resource exchange terminal releasing the second type of resources corresponding to the resource exchange amount to the user described in this embodiment may include a variety of specific implementations. For example, the resource exchange terminal may initiate a further notification to the user interaction interface thereof to notify the user holding the above account of the resource receiver, such as the resource exchange service user or other users, to release the second type of resources corresponding to the resource exchange amount to the client user.

Through the information exchange between the client of the user terminal and the resource exchange terminal, the user can execute, on the client, a transfer of a first type of resources to an account of a resource receiver designated by a resource exchange service user, thereby conveniently and quickly obtaining a second type of resources corresponding to an amount of the transferred first type of resources.

With the popularization and application of mobile payment, users have become more and more dependent on mobile payment, thereby reducing the amount of cash they carry. However, when there is a technical failure in mobile payment, or in business activities that do not support mobile payment or do not support currency payments from accounts of mobile users, cash payment becomes a necessary means of payment. In these cases, users are prone to cash shortages, which is particularly prominent when traveling in different places or foreign countries. In such cases, obtaining cash based on mobile clients has become a demand by users. In one or more embodiments described below in the present specification, the resource exchange method described in FIG. 1 is applied to a scenario in which a user makes cash withdrawals. In this application scenario, the resources include currency; the resource exchange includes cash withdrawal; the first type of resources includes electronic currency; and the second type of resources include cash currency.

Service users that provide users with cash withdrawals can include individual users or merchant users. In some embodiments, the resource exchange terminal includes a merchant terminal; the resource exchange interface includes a cash withdrawal interface; the account of the resource receiver includes a receiving account; the account of the resource provider includes an outgoing account (e.g., an account from which the resource is transferred); and the resource exchange amount includes a remittance amount.

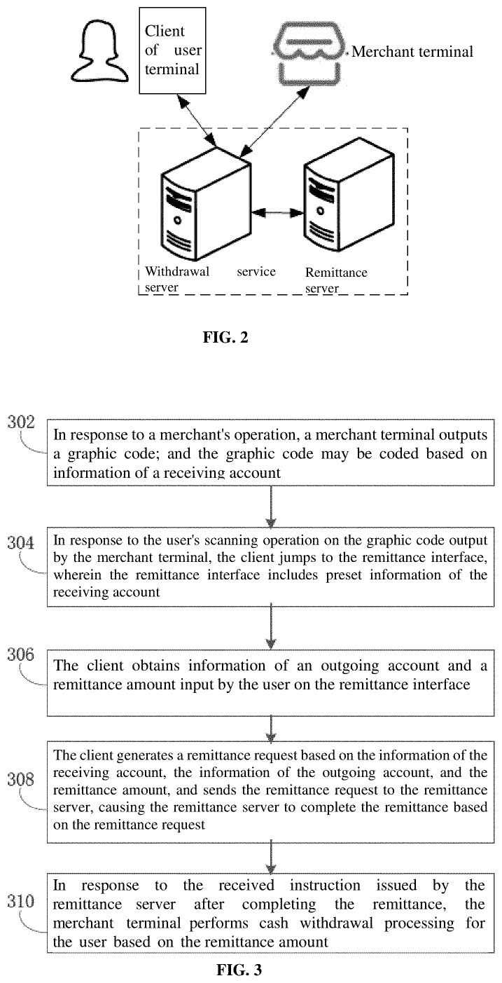

In view of this, one or more embodiments of the present specification provide a cash withdrawal method, which is applied to the system shown in FIG. 2 that includes a client of a user terminal, a merchant terminal, a withdrawal service server, and a remittance server. A withdrawing user executes remittance to an account designated by the merchant to obtain cash.

The withdrawal service server described in one or more embodiments of the present specification includes a service device that provides information exchange services required for cash withdrawal services for clients and merchant terminals. The remittance server described in one or more embodiments of the present specification is a business server located at a financial institution with remittance qualifications (such as a banking institution and a third-party payment institution). Users with withdrawal demands described in the present specification (or referred to as withdrawal users) have established outgoing accounts in the above remittance servers. In some embodiments, the remittance server may be a cloud server, which provides remittance services at lower technical cost.

It is worth noting that in the embodiment shown in FIG. 1, the resource exchange server integrates resource transfer (transferring the first type of resources from the account of the resource provider to the account of the resource receiver) and the resource exchange service communication (receiving a resource exchange request sent by the client of a user terminal and sending an instruction to the resource exchange terminal for releasing the second type of resources). In one or more embodiments provided in the present specification, the above two functions can be provided by the remittance server and the cash withdrawal service, respectively.

In some embodiments, the cash withdrawal service described in the present specification may be provided by a financial institution that performs remittance operations. As a result, the withdrawal service server and the remittance server may be the same service device belonging to the financial institution, or different service devices belonging to the financial institutions.

According to specific settings, the outgoing accounts may include one or more of financial account types, such as savings accounts, credit accounts, securities or fund accounts, and virtual resource accounts. The “remittance” mentioned in one or more embodiments of the present specification refers to the transfer of resources between users' financial accounts provided by the same or different financial institutions. The present specification does not limit the specific forms of the above resources. For example, monetary funds, securities, stocks, funds, virtual currencies, etc. can all be the above resources. Moreover, forms of resources remitted from an outgoing account and resources remitted into a receiving account can be the same or different. For example, the above remittance can be a transfer between funds in the same currency or between funds in different currencies, that is, a transfer between funds in different currencies at a set exchange rate.

FIG. 3 illustrates the flow of the withdrawal method provided by an exemplary embodiment of the present specification and applied to s client of a withdrawal user.

At Step 302, in response to a merchant's operation, a merchant terminal outputs a graphic code. The graphic code may be coded based on information of a receiving account.

In some embodiments, a user interface of the merchant terminal includes a function entry for triggering a withdrawal service, such as a function button for “help user withdraw cash.” After the merchant triggers this function, it can enter the user interface for generating the graphic code. The interface may include a prompt to the merchant to input the receiving account. The receiving account can be a financial account belonging to the merchant. The merchant can manually input its own receiving account, or click to select a constantly used account or an account of the merchant used in the past displayed in the user interface as the current receiving account. The receiving account can also be a financial account of a third-party user designated by the merchant. For example, when the user encounters a scenario that requires cash when traveling in a different place, the user can turn to another tourist user. The another tourist user can tell the merchant information of his/her receiving account, and the merchant manually inputs the information of the receiving account into the merchant terminal, or the information of the receiving account can be sent to the merchant terminal through the client of the another tourist user, causing the merchant terminal to generate, based on the information of the receiving account and a preset interface website, the graphic code.

In some embodiments, the graphic code is also integrated with URL information of a remittance page, allowing the client to perform the remittance operation on the remittance page designated by the URL. The URL can be a webpage URL generated separately by the merchant terminal for this payment operation, or can also be a fixed webpage URL preset by the merchant terminal.

At this time, after obtaining the information of the receiving account, the merchant terminal can perform graphical encoding based on the URL of the remittance page and the information of the receiving account to output a graphical code, such as a two-dimensional code.

At Step 304, in response to the user's scanning operation on the graphic code output by the merchant terminal, the client of the user terminal jumps to a remittance interface, wherein the remittance interface includes preset information of the receiving account.

In some embodiments, the client of the user terminal can analyze, based on the graphic code obtained by scanning, the content of the information carried by the graphic code, and obtain the information of the receiving account, then jump to the remittance interface, and automatically fill the obtained information of the receiving account to a corresponding position in the remittance interface where the receiving information is displayed.

The remittance interface may be a program interface set by a business program carried by the client, or may be a URL web page interface indicated in the graphic code.

In some embodiments, the client of the user terminal can analyze content of the information carried by the graphic code based on the graphic code obtained by scanning, and obtain the remittance interface URL and the information of the receiving account; then jump to the remittance interface indicated by the URL, and automatically fill the obtained information of the receiving account to a corresponding position in the remittance interface where the receiving information is displayed.

At Step 306, the client obtains information of an outgoing account and a remittance amount input by the user on the remittance interface.

In some embodiments, the user can manually input the information of his/her own outgoing account and remittance information on the remittance interface displayed on the client.

In some embodiments, the client can save the information of the financial account constantly used by the user or the information of a remittance account that has been used, and display it on the remittance interface for the user to select as the outgoing account for this remittance.

In some embodiments, the client can save a mapping relationship between the user's financial account information and the user's biological characteristics. By scanning the user's fingerprint or collecting the user's facial information, the client can obtain the user's fingerprint or the user's facial information, and can save the obtained financial account information to the remittance interface as the information of the outgoing account.

In some remittance operations, a user also needs to input other supplementary information on the remittance interface. For example, when the outgoing account and the receiving account are accounts opened with financial institutions in different countries, the remitting user needs to provide a description of usage of the remittance, which can include usage proof materials, such as text description or pictures, so as to facilitate the supervision of cross-border capital flow by the country where the outgoing account is located.

At Step 308, the client generates a remittance request based on the information of the receiving account, the information of the outgoing account, and the remittance amount, and sends the remittance request to the remittance server, causing the remittance server to complete the remittance based on the remittance request.

In order to prevent errors in the information of the receiving account obtained by the client, the client further needs to obtain confirmation of the information of the receiving account. The present embodiment does not limit the implementation of the confirmation. For example, the confirmation can be made by the merchant or the third party through confirming offline the information of the receiving account displayed on the client's remittance interface, and then the user clicks a button on the remittance interface to confirm the information of the receiving account; for another example, after the client scans the graphic code provided by the merchant terminal, the merchant terminal can output a prompt interface for the user to perform the remittance, the merchant terminal can send a confirmation message for the information of the receiving account displayed on the prompt interface, and the client can receive the confirmation message for the information of the receiving account sent by the merchant terminal, so as to obtain confirmation of the information of the receiving account, or, in response to the scanning operation of the client on the graphic code, the merchant terminal outputs, upon sensing that the client has scanned the graphic code provided by the merchant terminal, a voice prompt for confirming the information of the receiving account to prompt the merchant to perform a confirm operation on the merchant terminal for the information of the receiving account.

In some embodiments, the foregoing generating a remittance request based on the information of the receiving account, the information of the outgoing account, and the remittance amount includes: the client outputs to the user prompt information for confirming the information of the receiving account, wherein the prompt information may be sent by the withdrawal service server to the client, or may be pushed by a software program carried by the client to an interface between the client and the user based on preset business process settings; and, in response to the user's confirmation operation on the information of the receiving account, generates a remittance request based on the information of the receiving account, the information of the outgoing account, and the remittance amount.

For example, the remittance interface includes a confirmation option for confirming the information of the receiving account, and the confirmation option may be in the form of a confirmation button; the confirmation operation includes a trigger operation on the confirmation option, such as click to trigger.

In addition to the information of the receiving account, the information of the outgoing account, and the remittance amount information, the remittance request may also include a remittance exchange rate (if any), a remittance fee (if any), and payment verification information input by a user based on the client, as well as the supplementary information, such as a description of usage of the remittance. The payment verification information may include a payment key or verification code information, or biological verification information of a remitting user, such as fingerprint verification information, voiceprint verification information, iris verification information, face recognition verification information, etc., so as to enable the above remittance server to complete the remittance payment.

It is worth noting that the remittance request can be directly sent to the remittance server by the withdrawal client (when the remittance server and the withdrawal service server belong to the same financial institution), or can be sent by the withdrawal client to the withdrawal service server, and then the remittance request is forwarded by the withdrawal service server to the remittance server. The present specification does not have any limitation in this regard.

When the outgoing account and the receiving account belong to the same financial institution, the remittance server can deduct the remittance amount and a remittance processing fee (if any) from the outgoing account, and add the remittance amount to the receiving account.

When the outgoing account and the receiving account belong to different financial institutions, the remittance server can deduct the remittance amount and the remittance processing fee (if any) from the outgoing account, and then send a remittance notice to a server of the financial institution where the receiving account designated by the merchant is located, so as to add the remittance amount in the receiving account. At this moment, since the financial institution where the outgoing account is located and the financial institution where the receiving account is located may be different financial institutions, the two financial institutions may have no direct communication connection, and the above remittance may be transferred among multiple financial institution servers and finally reach the merchant's receiving account. Each financial institution participating in the transfer may charge a certain handling fee, resulting in that the remittance amount eventually received by the receiving account may be less than the above remittance amount.

When the outgoing account and the receiving account are accounts opened with financial institutions in different countries, the financial institution where the outgoing account is located may supervise cross-border capital flows and foreign exchanges. Therefore, In some embodiments, before the remittance is completed, the remittance server may also verify whether the remittance usage description included in the remittance application complies with preset remittance usage rules. If yes, the remittance operation is performed.

The preset remittance usage rules may be management rules set by the financial institution where the outgoing account is located for remittance usages based on national supervision laws and regulations. For example, when remittance is used for overseas consumption, the preset remittance usage rules include: the sum of the remittance amount used for overseas consumption from the outgoing account shall not exceed a preset threshold.

The preset remittance usage rules may also stipulate behaviors of converting remittance into tangible currency. For example, the type of the receiving account may be restricted to a merchant type (non-personal type), and the receiving account has the permission to receive remittance that meets the above description of remittance usage, that is, the merchant has the permission for services that convert remittance into tangible currency. Through the remittance usage rules, received amounts of the merchant user can be supervised.

Those skilled in the art can set various types and contents of user rules of remittance and inspection logic for the remittance server based on actual business demands and financial supervision requirements, all of which fall within the protection scope of the present specification.

After completing the remittance operation, the remittance server can directly or indirectly (forwarded by the withdrawal service server) send an instruction (such as a remittance certificate or withdrawal notice) to the merchant terminal, so as to instruct the merchant terminal to process a cash withdrawal for the user based on the remittance amount.

At Step 310, in response to the received instruction issued by the remittance server after completing the remittance, the merchant terminal performs cash withdrawal processing for the user based on the remittance amount.

In some embodiments, in response to the instruction, the merchant terminal further outputs a withdrawal prompt message to the merchant through a user interface, allowing the merchant or a third-party user related to the receiving account to perform cash withdrawal processing for the user based on the remittance amount.

This embodiment does not limit the implementation of the above withdrawal processing operation. In some embodiments, the merchant terminal is equipped with a box for holding cash and cash management intelligent hardware. The above process of performing, in response to the instruction, cash withdrawal processing for the user based on the remittance amount may include: in response to the instruction, controlling the cash management intelligent hardware associated with the merchant terminal, and outputting cash in an amount corresponding to the remittance amount from the cash held in the box.

The cash withdrawn above may be cash in an amount not greater than the remittance amount, for example, cash is provided to the user in accordance with the remittance amount. The cash and the remittance amount can be cash in the same currency or can be in different currencies.

In some embodiments, a fee that can be charged for cash withdrawal services may be set for merchants, so as to encourage merchants to participate in the above cash withdrawal services and provide users with cash.

When a third-party user (for example, another tourist user) is withdrawing cash for the user, in order to encourage users to provide cash withdrawal assistance to others, the withdrawal service system may provide rewards. The more times cash is provided to other users or a higher amount of cash is provided to other users by merchants or other ordinary users based on the steps described in steps 302 to 310, the more system rewards can be given, or the higher credit value can be accumulated.

Through the withdrawal methods described in the above embodiments, the user can quickly realize the remittance to the receiving account designated by the merchant based on the client scanning the graphic code output by the merchant terminal, thereby conveniently obtaining monetary funds.

In some embodiments, a user with withdrawal demands can also complete the withdrawal operation directly based on the merchant terminal device provided by the merchant.

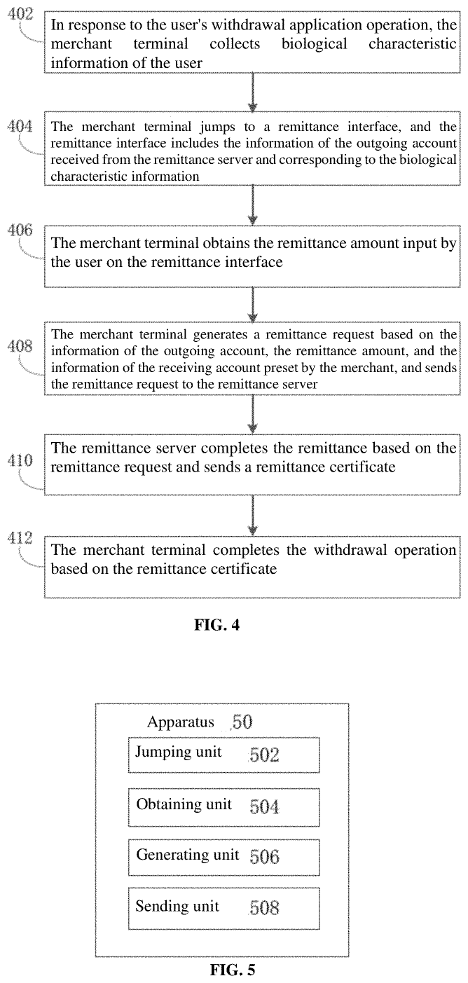

FIG. 4 illustrates the process of a withdrawal method provided by an exemplary embodiment of the present specification and applied to a merchant terminal. A withdrawal user (e.g., a user who would receive cash) has established an outgoing account on a remittance server, and the outgoing account is associated with biological characteristic information of the user. The biological characteristic information including one or more of the user's fingerprint information, voiceprint information, face recognition information, iris information, and other information. The withdrawal method described in the present embodiment includes the following steps.

At Step 402, in response to the user's withdrawal operation, the merchant terminal collects biological characteristic information of the user.

The user interface of the above merchant terminal includes a function entry for triggering the withdrawal, and the withdrawal operation is triggered by clicking the function entry or other operations.

The merchant terminal can be equipped with corresponding user biological feature information collection apparatuses, such as one or more of fingerprint collection apparatuses, voiceprint collection apparatuses, facial information collection apparatuses such as cameras, and iris feature collection apparatuses. After collecting the biological characteristic information, the merchant terminal can send or forward the above biological characteristic information to the remittance server through the withdrawal service server, causing the remittance server to retrieve a corresponding outgoing account of the withdrawal user based on the above biological characteristic information, and send or forward the information of the outgoing account through the withdrawal service server to the merchant terminal.

At Step 404, the merchant terminal jumps to a remittance interface, which includes the information of the outgoing account received from the remittance server and corresponding to the biological characteristic information.

In some embodiments, in order to prevent errors in the outgoing account retrieved by the remittance server, the remittance interface further includes a confirmation button corresponding to the information of the outgoing account, allowing the user to click the confirmation button for confirming the information of the outgoing account on the remittance interface.

At Step 406, the remittance amount input by the user on the remittance interface is obtained.

In some remittance operations, a user also needs to input other supplementary information on the remittance interface. For example, when the outgoing account and the receiving account are accounts opened with financial institutions in different countries, the remitting user needs to provide a description of usage of the remittance, which can include proof-of-usage materials, such as text description or pictures, so as to facilitate the supervision of cross-border capital flow by the country where the outgoing account is located.

At Step 408, the merchant terminal generates a remittance request based on the information of the outgoing account, the remittance amount, and the information of the receiving account preset by the merchant, and sends the remittance request to the remittance server.

In addition to the information of the receiving account, the information of the outgoing account, and the remittance amount information, the remittance request may also include a remittance exchange rate (if any), a remittance fee (if any), and payment verification information input by a user based on the merchant terminal, as well as the supplementary information, such as a description of usage of the remittance. The above payment verification information may include payment key or verification code information, or biological verification information of a withdrawal user, such as fingerprint verification information, voiceprint verification information, iris verification information, face recognition verification information, etc., so as to enable the above remittance server to complete the above remittance payment.

It is worth noting that the remittance request can be directly sent to the remittance server by the withdrawal client (when the remittance server and the withdrawal service server belong to the same financial institution), or can be sent by the withdrawal client to the withdrawal service server, and then the remittance request is forwarded by the withdrawal service server to the remittance server. The present specification does not have any limitation in this regard.

At Step 410, the remittance server completes the remittance based on the remittance request and sends a remittance certificate.

After completing the remittance operation, the remittance server may directly or indirectly (forwarded by the withdrawal service server) send the remittance certificate to the above merchant terminal.

When the outgoing account and the receiving account belong to the same financial institution, the remittance server can deduct the remittance amount and a remittance processing fee (if any) from the outgoing account, and add the remittance amount to the receiving account.

When the outgoing account and the receiving account belong to different financial institutions, the remittance server can deduct the remittance amount and the remittance processing fee (if any) from the outgoing account, and then send a remittance notice to a server of the financial institution where the receiving account of the merchant is located, so as to add the remittance amount in the receiving account. At this moment, since the financial institution where the outgoing account is located and the financial institution where the receiving account is located may be different financial institutions, the two financial institutions may have no direct communication connection, and the above remittance may be transferred among multiple financial institution servers and finally reach the merchant's receiving account. Each financial institution participating in the transfer may charge a certain handling fee, resulting in that the remittance amount eventually received by the receiving account may be less than the above remittance amount.

When the outgoing account and the outgoing account are accounts opened with financial institutions in different countries, the financial institution where the outgoing account is located may supervise actions such as cross-border capital flows and foreign exchanges. Therefore, in some embodiments, before the remittance is completed, the remittance server may also verify whether the remittance usage description included in the remittance application complies with preset remittance usage rules. If in compliance, the remittance operation is performed.

The preset remittance usage rules may be management rules set by the financial institution where the outgoing account is located for remittance usages based on national supervision laws and regulations. For example, when remittance is used for overseas consumption, the preset remittance usage rules may include: the sum of the remittance amount used for overseas consumption from the outgoing account shall not exceed a preset threshold.

The preset remittance usage rules may also stipulate behaviors of converting remittance into tangible currency. For example, the type of the receiving account may be restricted to a merchant type (non-personal type), and the receiving account has the permission to receive remittance that meets the above description of remittance usage, that is, the merchant has the permission for services that convert remittance into tangible currency. Through the remittance usage rules, received amounts of the merchant can be supervised.

Those skilled in the art can set various types and contents of remittance usage rules and inspection logic for the remittance server based on actual business needs and financial supervision requirements, all of which fall within the protection scope of the present specification.

At Step 412, the merchant terminal completes the withdrawal operation based on the remittance certificate.

The present embodiment does not limit the implementation of the above withdrawal operation. In some embodiments, the merchant terminal may be provided with a cash exit. After receiving the above remittance certificate, the merchant terminal may automatically output, to the cash exit, cash in an amount corresponding to the remittance certificate.

In some embodiments, the merchant terminal may output a withdrawal prompt message to a front-end display page, allowing the merchant to provide the user with cash in the amount corresponding to the remittance certificate.

The cash in the amount corresponding to the remittance certificate may be monetary cash in an amount not greater than the remittance amount in the remittance certificate. In the cash withdrawal services provided in the present specification, a fee that can be charged for cash withdrawal services may be set for merchants, so as to encourage merchants to participate in the above cash withdrawal services and provide users with cash.

Through the remittance and withdrawal steps including steps 402 to 412 described in the above embodiment, the user can quickly realize the remittance to the merchant's receiving account based on the merchant terminal device provided by the merchant, thereby conveniently obtaining monetary funds from the merchant.

It is worth noting that the information content included in the remittance interface described in one or more of the above embodiments of the present specification can be actually displayed on one page of the terminal or on multiple pages. The present specification does not have any limitation in this regard.

Corresponding to the implementation of the above process, the embodiments of the present specification also provide resource exchange apparatuses 50 and 60. The apparatuses 50 and 60 can be implemented by software, or can be implemented by hardware or a combination of software and hardware. Taking software implementation as an example, as a logical apparatus, it is formed by reading corresponding computer program instructions into a memory by a Central Process Unit (CPU) of a device where it is located. From a hardware perspective, in addition to the CPU, memory, and internal memory shown in FIG. 7, the device where the apparatus is located usually also includes other hardware such as chips for wireless signal transmission and reception and/or other hardware such as boards for implementing network communication functions.

As shown in FIG. 5, the present specification also provides a resource exchange apparatus 50 applied to a client, and the apparatus 50 includes:

a jumping unit 502 configured to jump, in response to a scanning operation by a user on a graphic code output by a resource exchange terminal, to a resource exchange interface, wherein the resource exchange interface includes information of a preset account of a resource receiver;

an obtaining unit 504 configured to obtain information of an account of a resource provider and a resource exchange amount input by the user on the resource exchange interface;

a generating unit 506 configured to generate a resource exchange request according to the information of the account of the resource receiver, the information of the account of the resource provider, and the resource exchange amount; and

a sending unit 508 configured to send the resource exchange request to a resource exchange server, causing the resource exchange server to respond to the resource exchange request, transfer a first type of resources corresponding to the resource exchange amount from the account of the resource provider to the account of the resource receiver, and after the transfer of the first type of resources is completed, instruct the resource exchange terminal to release a second type of resources corresponding to the resource exchange amount to the user.

In some embodiments, the generating unit 506 is further configured to:

output to the user a prompt information interface for confirming the information of the account of the resource receiver; and

in response to the user's confirmation operation on the information of the account of the resource receiver, generating a resource exchange request according to the information of the account of the resource receiver, the information of the account of the resource provider, and the resource exchange amount.

In some embodiments, the resource exchange interface includes a confirmation option for confirming the information of the account of the resource receiver; and the confirmation operation includes a trigger operation on the confirmation option.

In some embodiments, the resources include currency; the resource exchange includes cash withdrawal; the first type of resources includes electronic currency; and the second type of resources include cash currency.

In some embodiments, the resource exchange includes cross-currency cash withdrawal.

In some embodiments, the resource exchange terminal includes a merchant terminal; the resource exchange interface includes a cash withdrawal interface; the account of the resource receiver includes a receiving account; the account of the resource provider includes an outgoing account; and the resource exchange amount includes a remittance amount.

For a detailed implementation process of functions and roles of various units in the apparatus 50, please refer to the corresponding implementation steps in the resource exchange method executed by the client of the user terminal. For related details, please refer to the description of the method implementations above, which will not be repeated here.

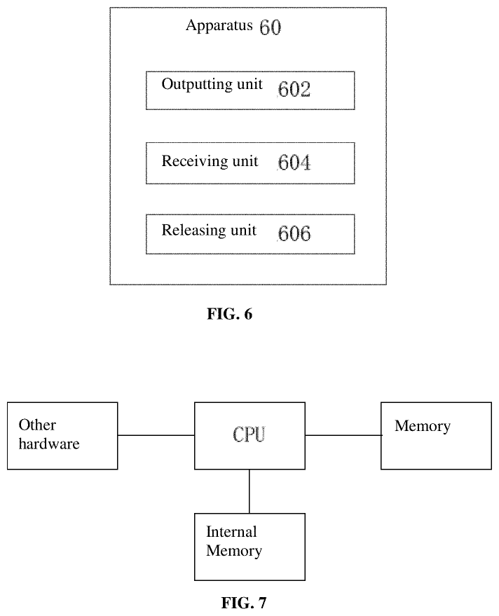

Correspondingly, as shown in FIG. 6, the present specification also provides a resource exchange apparatus 60 applied to a resource exchange terminal, and the apparatus 60 includes:

an outputting unit 602 configured to output, in response to an operation by a resource exchange service user, a graphic code, allowing the user to jump to a resource exchange interface by scanning the graphic code using a client and input information of an account of a resource provider and a resource exchange amount on the resource exchange interface, wherein the resource exchange interface includes information of a preset account of a resource receiver;

a receiving unit 604 configured to receive an instruction issued by a resource exchange server after completing a transfer of the first type of resources corresponding to the resource exchange amount from the account of the resource provider to the account of the resource receiver based on a resource exchange request sent by the client, wherein the resource exchange request is generated by the client based on the information of the account of the resource receiver, the information of the account of the resource provider, and the resource exchange amount; and

a releasing unit 606 configured to release, in response to the instruction, a second type of resources corresponding to the resource exchange amount to the user.

In some embodiments, the user interface of the resource exchange terminal includes a function entry for triggering the resource exchange; and

the outputting unit 602 is further configured to: in response to a trigger operation of the resource exchange service user on the function entry, output the graphic code.

In some embodiments, the outputting unit 602 is further configured to: in response to the scanning operation on the graphic code by the client, outputting a voice prompt for confirming the information of the preset account of the resource receiver included in the resource exchange interface.

In some embodiments, the releasing unit 606 is further configured to: in response to the instruction, further output to the resource exchange service user through the user interface of the resource exchange terminal a prompt message for releasing the second type of resources corresponding to the resource exchange amount to the user.

In some embodiments, the resources include currency; the resource exchange includes cash withdrawal; the first type of resources includes electronic currency; and the second type of resources includes cash currency.

In some embodiments, the resource exchange terminal includes a merchant terminal; the resource exchange interface includes a cash withdrawal interface; the account of the resource receiver includes a receiving account; the account of the resource provider includes an outgoing account; and the resource exchange amount includes a remittance amount.

For a detailed implementation process of functions and roles of various units in the apparatus 60, please refer to the corresponding implementation steps in the resource exchange method executed by the resource exchange terminal. For related details, please refer to the description of the method implementations, which will not be repeated here.

The apparatus implementations described above are merely illustrative, where the units described as separate components may or may not be physically separate, and the components displayed as units may or may not be physical modules, that is, they may be located in one place, or may be distributed to multiple network modules. Some or all of the units or modules thereof can be selected according to actual needs to achieve the purpose of the solution of the present specification, which can understood and implemented by those of ordinary skill in the art without creative effort.

The apparatuses, units, and modules set forth in the foregoing embodiments may be specifically implemented by computer chips or entities, or implemented by products with certain functions. A typical implementation device is a computer. The specific form of the computer can be a personal computer, a laptop computer, a cellular phone, a camera phone, a smart phone, a personal digital assistant, a media player, a navigation device, an email receiving and sending device, a game control console, a tablet computer, a wearable device, or a combination of any of these devices.

Corresponding to the foregoing method embodiments, the embodiments of the present specification also provide a computer device. As shown in FIG. 7, the computer device includes a memory and a processor. Here, the memory stores a computer program executable by the processor. When executing the stored computer program, the processor executes the steps of the resource exchange method executed by the client of the user terminal in the embodiments of the present specification. The previous content may be referenced for a detailed description of the steps of the resource exchange method executed by the client of the user terminal, which will not be repeated.

Corresponding to the foregoing method embodiments, the embodiments of the present specification also provide a computer device. As shown in FIG. 7, the computer device includes a memory and a processor. Here, the memory stores a computer program executable by the processor. When executing the stored computer program, the processor executes the steps of the resource exchange method executed by the resource exchange terminal in the embodiments of the present specification. The previous content may be referenced for a detailed description of all the steps of the resource exchange method executed by the resource exchange terminal, which will not be repeated.

The description above are merely preferred embodiments of the present specification. Any modification, equivalent exchange, improvement, and the like made within the spirit and principle of the present specification shall be encompassed by the protection scope of the present specification.

In a typical configuration, a computing device includes one or more processors (CPUs), input/output interfaces, network interfaces, and memories.

The memories may include a non-permanent memory, a random access memory (RAM), and/or a non-volatile memory in computer-readable media, such as a read-only memory (ROM) or a flash memory (flash RAM). The memories are an example of non-transitory computer readable media.

Computer-readable media include permanent and non-permanent, as well as removable and non-removable, media, and information storage can be realized by any method or technology. The information can be computer-readable instructions, data structures, program modules, or other data.

Examples of computer storage media include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), a digital versatile disc (DVD) or other optical storage, a magnetic cassette, a magnetic tape storage or other magnetic storage devices, or any other non-transmission media, which can be used to store information that can be accessed by a computing device. According to the definition herein, computer-readable media do not include transitory media, such as modulated data signals and carrier waves.

It should also be noted that the terms “include,” “comprise,” or any other variants thereof are intended to cover non-exclusive inclusion, causing a process, a method, a commodity, or a device including a series of elements to not only include those elements, but also include other elements that are not explicitly listed, or also include elements inherent to such process, method, commodity, or device. Given that there are no more restrictions, the element defined by the sentence “including a . . . ” does not exclude the existence of other identical elements in the process, method, commodity, or device that includes the element.

Those skilled in the art should understand that the embodiments of the present specification can be provided as a method, a system, or a computer program product. Therefore, the embodiments of the present specification may adopt the form of a complete hardware embodiment, a complete software embodiment, or an embodiment combining software and hardware. Moreover, the embodiments of the present specification can take a form of a computer program product implemented on one or more computer-usable storage media (including but not limited to a magnetic disk memory, a CD-ROM, an optical memory, etc.) containing computer-usable program code.

1. A resource exchange method, the method comprising:
scanning, by a user terminal, a graphic code displayed on a resource exchange terminal;
in response to obtaining the graphic code, jumping, by a processor of the user terminal, to a resource exchange interface, wherein the resource exchange interface comprises information of an account of a resource receiver;
obtaining, by the processor of the user terminal, information of an account of a resource provider and a resource exchange amount input by a user on the resource exchange interface; and
according to the information of the account of the resource receiver, the information of the account of the resource provider, and the resource exchange amount, generating, by the processor of the user terminal, a resource exchange request, and sending the resource exchange request to a resource exchange server, causing the resource exchange server to:
transfer resources of a first type corresponding to the resource exchange amount from the account of the resource provider to the account of the resource receiver, and
after the transfer of the first type of resources is completed, instruct the resource exchange terminal to release resources of a second type corresponding to the resource exchange amount to the user, wherein the second type is different from the first type.

2. The method according to claim 1, wherein the generating a resource exchange request comprises:
displaying a prompt information interface for confirming the information of the account of the resource receiver; and
in response to a confirmation operation by the user on the information of the account of the resource receiver, generating the resource exchange request according to the information of the account of the resource receiver, the information of the account of the resource provider, and the resource exchange amount.

3. The method according to claim 2, wherein the resource exchange interface comprises a confirmation option for confirming the information of the account of the resource receiver; and the confirmation operation comprises a trigger operation on the confirmation option.

4. The method according to claim 1, wherein the first type of resources comprises electronic currency, and the second type of resources comprises cash currency.

5. The method according to claim 4, wherein the resource exchange comprises cross-currency cash withdrawal.

6. The method according to claim 1, further comprising:
in response to an operation by a user on the resource exchange terminal, outputting, by a processor of the resource exchange terminal, the graphic code;
receiving, by the processor of the resource exchange terminal, an instruction issued by the resource exchange server after completing the transfer of the first type of resources; and
in response to receiving the instruction, releasing, by the processor of the resource exchange terminal, the second type of resources corresponding to the resource exchange amount to the user.

7. The method according to claim 6, further comprising:
displaying an user interface on the resource exchange terminal, wherein the user interface comprises a function entry for triggering a resource exchange; and
in response to a trigger operation on the function entry, outputting the graphic code.

8. The method according to claim 6, further comprising:
in response to a scanning operation on the graphic code by the user terminal, outputting a voice prompt for confirming the information of the account of the resource receiver included in the resource exchange interface.

9. The method according to claim 6, wherein in response to the instruction, releasing the second type of resources corresponding to the resource exchange amount to the user comprises:
in response to the instruction, outputting to the user through the user interface of the resource exchange terminal a prompt message for releasing the second type of resources corresponding to the resource exchange amount to the user.

10. One or more non-transitory computer-readable media configured with instructions executable by a resource exchange system to cause the resource exchange system to perform operations comprising:
scanning, by a user terminal of the resource exchange system, a graphic code displayed on a resource exchange terminal of the resource exchange system;
in response to obtaining the graphic code, jumping, by a processor of the user terminal, to a resource exchange interface, wherein the resource exchange interface comprises information of an account of a resource receiver;
obtaining, by the processor of the user terminal, information of an account of a resource provider and a resource exchange amount input by a user on the resource exchange interface; and
according to the information of the account of the resource receiver, the information of the account of the resource provider, and the resource exchange amount, generating, by the processor of the user terminal, a resource exchange request, and sending the resource exchange request to a resource exchange server of the resource exchange system, causing the resource exchange server to:
transfer resources of a first type corresponding to the resource exchange amount from the account of the resource provider to the account of the resource receiver, and
after the transfer of the first type of resources is completed, instruct the resource exchange terminal to release resources of a second type corresponding to the resource exchange amount to the user, wherein the second type is different from the first type.

11. The one or more non-transitory computer-readable media according to claim 10, wherein the generating a resource exchange request comprises:
displaying a prompt information interface for confirming the information of the account of the resource receiver; and
in response to a confirmation operation by the user on the information of the account of the resource receiver, generating the resource exchange request according to the information of the account of the resource receiver, the information of the account of the resource provider, and the resource exchange amount.

12. The one or more non-transitory computer-readable media according to claim 11, wherein the resource exchange interface comprises a confirmation option for confirming the information of the account of the resource receiver; and the confirmation operation comprises a trigger operation on the confirmation option.

13. The one or more non-transitory computer-readable media according to claim 10, wherein the first type of resources comprises electronic currency, and the second type of resources comprises cash currency.

14. The one or more non-transitory computer-readable media according to claim 13, wherein the resource exchange comprises cross-currency cash withdrawal.

15. The one or more non-transitory computer-readable media according to claim 10, wherein the operations further comprise:
in response to an operation by a user on the resource exchange terminal, outputting, by a processor of the resource exchange terminal, the graphic code;
receiving, by the processor of the resource exchange terminal, an instruction issued by the resource exchange server after completing the transfer of the first type of resources; and
in response to receiving the instruction, releasing, by the processor of the resource exchange terminal, the second type of resources corresponding to the resource exchange amount to the user.

16. The one or more non-transitory computer-readable media according to claim 15, wherein the operations further comprise:
displaying an user interface on the resource exchange terminal, wherein the user interface comprises a function entry for triggering a resource exchange; and
in response to a trigger operation on the function entry, outputting the graphic code.

17. The one or more non-transitory computer-readable media according to claim 15, wherein the operations further comprise:
in response to a scanning operation on the graphic code by the user terminal, outputting a voice prompt for confirming the information of the account of the resource receiver included in the resource exchange interface.

18. The one or more non-transitory computer-readable media according to claim 15, wherein in response to the instruction, releasing the second type of resources corresponding to the resource exchange amount to the user comprises:
in response to the instruction, outputting to the user through the user interface of the resource exchange terminal a prompt message for releasing the second type of resources corresponding to the resource exchange amount to the user.

19. A system comprising:
a user terminal;
a resource exchange terminal; and
a resource exchange server, wherein the user terminal is configured to:
scan a graphic code displayed on the resource exchange terminal;
in response to obtaining the graphic code, jump to a resource exchange interface, wherein the resource exchange interface comprises information of an account of a resource receiver;
obtain information of an account of a resource provider and a resource exchange amount input by a user on the resource exchange interface; and
according to the information of the account of the resource receiver, the information of the account of the resource provider, and the resource exchange amount, generate a resource exchange request, and sending the resource exchange request to the resource exchange server, causing the resource exchange server to:
transfer resources of a first type corresponding to the resource exchange amount from the account of the resource provider to the account of the resource receiver, and
after the transfer of the first type of resources is completed, instruct the resource exchange terminal to release resources of a second type corresponding to the resource exchange amount to the user, wherein the second type is different from the first type.

20. The system according to claim 19, wherein the generating a resource exchange request comprises:
displaying a prompt information interface for confirming the information of the account of the resource receiver; and
in response to a confirmation operation by the user on the information of the account of the resource receiver, generating the resource exchange request according to the information of the account of the resource receiver, the information of the account of the resource provider, and the resource exchange amount.
